(19) United States
(12) Patent Application Publication
(10) Pub. No.: US 2007/0046454 A1
(43) Pub. Date: Mar. 1, 2007

(54) Photocell activated switch for use with seven ways connector

(76) Inventor: Martin Bienvenue, Ste-Anne-Des-Plaines (CA)

Correspondence Address: INVENTARIUM;Suite 1607, 4050 Rosemont blvd, Montreal, QC, H1X 1M4, CA

(21) Appl. No.: 11/512,586

(22) Filed: Aug. 30, 2006

Related U.S. Application Data
(60) Provisional application No. 60/712,247, filed on Aug. 30, 2005.

(51) Int. Cl. B60Q 1/22

(52) U.S. Cl. 340/463

(57) ABSTRACT

A Photocell activated switch for use with seven ways connector has specially designed electronic components that fits inside a seven ways connector so that by connecting the device into a seven ways connector, external lights on a camper trailer can be controlled independently from the towing vehicle.

This application claims priority based on provisional application 60/712,247 filed Aug. 30, 2005

### FIELD OF THE INVENTION

The invention relates generally to electronic components but more particularly to a component that fits into an otherwise standard seven ways connector.

### BACKGROUND OF THE INVENTION

There exists several examples of systems aimed at turning on the lights of trailers so that they are more visible at night. Some systems use photocell to automatically turn on the lights when ambient luminosity is low. However, these systems require specially designed wiring and components that are complicated to install.

### SUMMARY OF THE INVENTION

In view of the foregoing disadvantages inherent in the known devices now present in the prior art, the present invention, which will be described subsequently in greater detail, is to provide objects and advantages which are:

To provide for a lighting system for trailers by way of a unit of a size and configuration that is similar to that of a seven ways connector.

In order to do so, the invention comprises specially designed electronic components that connects with a seven ways connector, one model fits into a female seven ways connector while another model fits into a male seven ways connector. Anything connected to the seven ways connector will be controlled by the electronics inside the device. Among other things, the electronic components includes a photocell.

The photocell activated switch has a shell configured and sized to interact with a seven ways connector whether male or female. Inside the shell are seven metal connectors which are male or female depending on whether the photocell activated switch is male or female. The shell is further comprised of electronic components and a photocell. The shell has an opening so that ambient external light can shine on the photocell.

The electronic components are further comprised of a potentiometer, a comparator, and an amplifier.

In use, the photocell activated switch has the following mode of operation:

The photocell detects the presence of light as regulated by the potentiometer, the potentiometer adjusts for light sensitivity and sends a signal to a comparator which determines if the value given by the signal means that there is not enough ambient light and that lights must be turned on or that there is still enough ambient light and lights need not be turned on yet. The amplifier provides an output signal to the metal connectors so that the photocell activated switch triggers a response.

This invention takes advantage of a well known and used component in the field of motorized camping that has a structural body that has been shown to be weather resistant and durable and so, by using a similar shape and using similar materials, it is easy to have a device that can easily interface with a seven ways connector and that is durable, compact and easy to use.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. For example, a timer can be optionally added to the device without departing from the scope of the invention since such a feature is well known in the art and so is a master switch. Also, the technology is applicable to a variety of trailers, motorhomes, campers and any related structure where a seven ways connector can be used. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIGS. 1a-c Side view of a trailer and towing vehicle with a female photocell activated switch for use with seven ways male connector.

FIGS. 2a-c Side view of a trailer and towed vehicle with a male photocell activated switch for use with seven ways female connector.

FIGS. 3ab Cutaway side views of a male and female photocell activated switch for use with seven ways connector, respectively.

FIG. 4 Schematic view of the electronics inside the photocell activated switch for use with seven ways connector.

### DETAILED DESCRIPTION

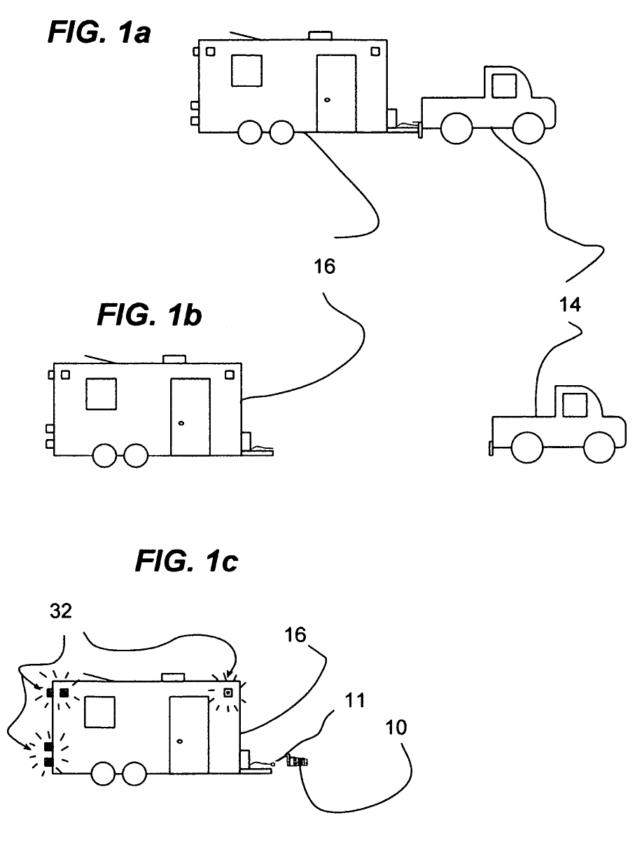

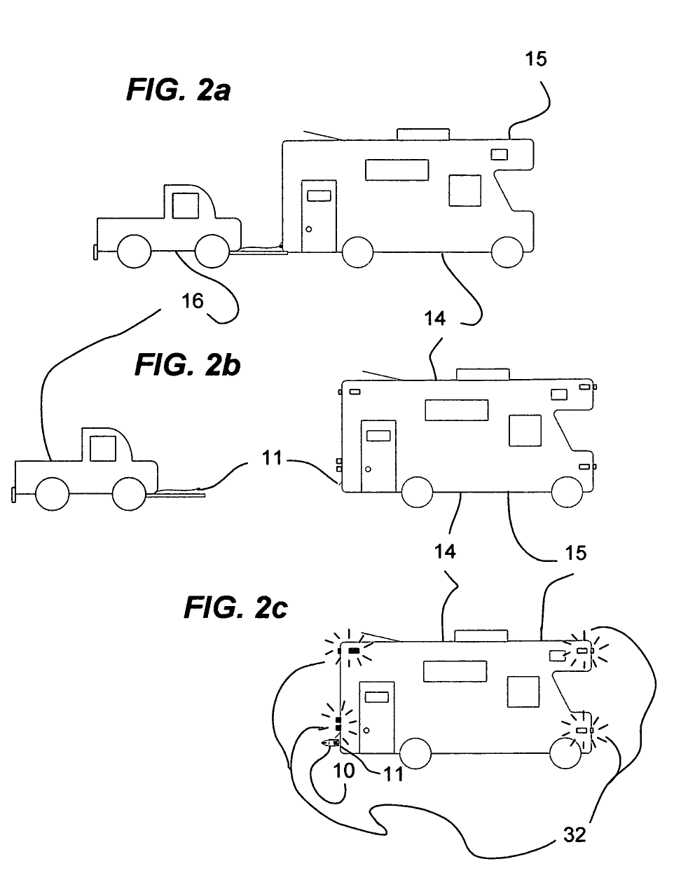

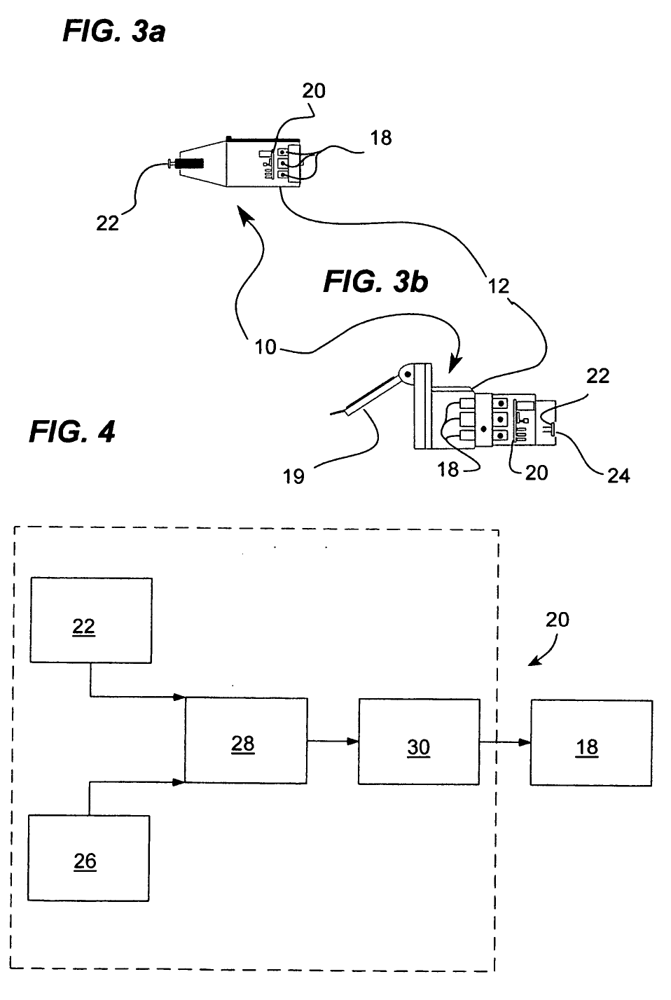

A photocell activated switch (10) for use with seven ways connector (11) has a shell (12) having a size and an external shape similar to seven ways connectors as are known in the art—whether they be male or female seven ways connectors, in other words, there are two variations of the photocell activated switch (10), a male and a female—and is generally positioned on a towed vehicle or trailer (16) as per FIGS. 1ab, or a towing vehicle (14) as per FIGS. 2ab. The photocell activated switch (10) is used as a switch to turn on the external lights of a recreational vehicle (15). Inside the shell (12) are the seven metal connectors (18), (male or female as the case may be) as is known in the art that make the electrical contact between the photocell activated switch (10) and the seven ways connector (11) possible, as well as a flip cover (19) for the female connector, but additionally, the photocell activated switch (10) has electronic components (20) and a photocell (22). The shell (12) has an opening so that ambient external light can shine on the photocell (22).

In operation, the photocell (22) detects the presence of light as regulated by a potentiometer (26) which is part of the electronic components (20). The potentiometer (26) adjusts for light sensitivity and sends a signal to a comparator (28) which determines if the value given by the signal means that there is not enough ambient light and that lights must be turned on or that there is still enough ambient light and lights need not be turned on yet. An amplifier (30) provides an output signal to the metal connectors (18) so that the photocell activated switch (10) triggers the appropriate response, that is, act as a switch which, when turned on, has the external lights of a recreational vehicle (15) turned on or stay on and when the photocell activated switch (10) is turned off, external lights of a recreational vehicle (15) will be turned off or stay off.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A photocell activated switch for use with seven ways connector positioned on a towed vehicle or trailer comprising:
a shell configured and sized to interact with a seven ways connector whether male or female;
inside said shell are metal connectors which are male or female depending on whether said photocell activated switch is male or female to make electrical contact between said photocell activated switch and said seven ways connector;
said shell is further comprised of electronic components and a photocell; said shell having an opening so that ambient external light can shine on said photocell.

2. A photocell activated switch as in claim 1 wherein:
said electronic components further comprised of a potentiometer, a comparator, and an amplifier.

3. A photocell activated switch as in claim 1 having the following mode of operation:
said photocell detects the presence of light as regulated by a potentiometer which is part of said electronic components;
said potentiometer adjusts for light sensitivity and sends a signal to a comparator which determines if the value given by said signal means that there is not enough ambient light and that lights must be turned on or that there is still enough ambient light and lights need not be turned on yet;
an amplifier provides an output signal to said metal connectors so that said photocell activated switch triggers a response.
